(19) United States
(12) Patent Application Publication
(10) Pub. No.: US 2025/0320324 A1
(43) Pub. Date: Oct. 16, 2025

(54) Method for preparing lignin-phenol-formaldehyde resins of controlled viscosity

(71) Applicant: Chempolis Oy, Oulu (FI)

(72) Inventors: Hanne Wikberg, Espoo (FI); Harri Setälä, Espoo (FI); Petri Widsten, Espoo (FI)

(21) Appl. No.: 18/868,806

(22) PCT Filed: May 24, 2023
(86) PCT No.: PCT/EP2023/063940

§ 371 Date: Nov. 25, 2024

(30) Foreign Application Priority Data
May 25, 2022 (FI) 20225456

(51) Int. Cl. C08G 16/06

(52) U.S. Cl. CPC C08G 16/06

(57) ABSTRACT

The present invention relates to a method for solubilising a lignin material and controlling its molecular weight, in order to prevent the potential decrease in its reactivity, and thereby controlling the viscosity of both the lignin material and the obtained condensation product. The method thus comprises dissolving the lignin in acidic conditions using a first fraction of phenol, and then carrying out a methylolation in alkaline conditions, as well as a condensation and a crosslinking, in order to produce a final resin product.

### BACKGROUND OF THE INVENTION

### Field of the Invention

The present invention relates to a method for manufacturing lignin-phenol-formaldehyde resins having a controlled viscosity. Further, the invention relates to the resins thus produced.

### Description of Related Art

Phenol-formaldehyde resins (or PF resins) are a widely used group of adhesives derived from oil and natural gas, suitable for a wide range of reconstituted wood products such as plywood, laminated veneer lumber, fiberboard and particleboard as well as decorative laminates and molding compounds. In order to provide more sustainable alternatives, there is a wide interest for replacing some of the phenol in the resin formulations.

Use of lignin has been a preferred alternative for replacing phenol in such resins, thus producing lignin-phenol-formaldehyde resins (LPF resins), since lignin is a phenol-based natural compound. Commonly, the lignin is solubilised, and possibly further activated, e.g. by phenolation or depolymerisation, prior to its use in resin production. Selecting the suitable conditions for these steps is essential, since this will affect the reactivity of the lignin with the other components of the resin.

The lignin solubility can be improved in various ways. For example, lignin can be solubilised in alkali or an organic solvent such as methanol. In US20190048192 A1, lignin was dissolved in methanol at alkaline conditions. Methanol is, however, to be avoided in such industrial processes, among other reasons due to its flammability.

Lignin has been activated toward formaldehyde by phenolation in the past. WO 2015079106 A1 describes a method for reacting lignin with phenol in neutral or alkaline conditions. The option of mixing the reactants at pH levels <8 is discussed, but since alkali is added, the pH will not reach acidic levels. However, neutral or alkaline conditions are not suitable for use with all lignin types and may result in a resin with a high viscosity due to, among other reasons, lignin condensation and/or the formation of poorly soluble aggregates, thus resulting in a poor reactivity of the lignin towards formaldehyde and high resin viscosities.

The present inventors have surprisingly found that the resin properties can be significantly improved, and a wider range of suitable lignin types can be provided, by changing the conditions of the lignin solubilisation in such a way that lignin reactivity in the following reaction with formaldehyde will not be impaired by harmful self-condensation reactions, resulting in a controlled viscosity of the resin.

### SUMMARY OF THE INVENTION

The invention is defined by the features of the independent claims. Some specific embodiments are defined in the dependent claims.

According to a first aspect of the present invention, there is provided a method for solubilising a lignin material and preventing the potential decrease in its reactivity, thus maintaining its suitability for use in the manufacture of resins.

According to a second aspect of the present invention, there is provided a method for manufacturing lignin-phenol-formaldehyde resins using said solubilised lignin material.

According to a third aspect of the invention, there is provided a method for manufacturing lignin-phenol-formaldehyde resins using a wide range of suitable lignin starting materials, originating from different types of biomasses and fractionation processes.

According to a further aspect of the invention, there is provided a novel lignin-phenol-formaldehyde resin with advantageous properties.

The present invention is thus based on providing a solubilised lignin material and using it as a partial replacement of the phenol of phenol-formaldehyde resins. Typically, the aim is to replace 30-50% of the phenol of such resins.

Said solubilisation aims at preventing self-condensation of lignin that would increase its molecular weight, lowering its reactivity towards formaldehyde and increasing resin viscosity to an undesirable level.

The invention thus includes a dissolution of the lignin in acidic conditions using phenol, preventing condensation of lignin into molecules or poorly soluble aggregates having a higher molecular weight, which would take place using some lignin materials. The dissolution of the present method will result in a lignin that is sufficiently reactive towards formaldehyde, regardless of the type of lignin that has been used. At least kraft lignin, soda pulping lignin, lignosulfonate, organosolv lignin and ethanol process lignin are suitable for use in the method of the present invention.

Phenolation has been described in the past as a method for activating lignin, but the present invention is based on an alternative procedure, where phenol is used to provide dissolution of the lignin, as well as to prevent the potential detrimental increase in the molecular weight of the lignin prior to its reaction with formaldehyde.

The inventors have found that a significant advantage is achieved, using the present invention, when dissolution of the lignin is carried out under phenol-induced acidic conditions. No additional acids are required in the dissolution step beyond the components used for regular resin manufacture. Under such conditions of phenol-induced acidity, a reduction of the reactivity of the lignin, e.g., by self-condensation or aggregate formation, which has been shown to take place with some lignin raw materials under neutral or alkaline conditions, will be prevented. As a consequence, also an undesirable increase in final resin viscosity, resulting from excessively high molar mass of lignin, will be prevented. Without wishing to be bound by a specific theory, we hypothesise that the phenol molecules, in addition to acting as a solvent, may act as a physical barrier between the lignin molecules that could otherwise condense into higher molecular weight lignin structures of reduced reactivity toward formaldehyde and resulting in higher resin viscosities.

Based on investigations of isolated lignins, we further hypothesise, again without wishing to be bound by a specific theory, that the acidic conditions may also result in beneficial changes to the lignin structure such as cleavage of alkyl-aryl ether linkages between lignin units that may enhance its reactivity toward formaldehyde by creating new phenolic hydroxyl groups and lowering its molar mass, while some non-essential elements of lignin such as ester groups in organosolv lignins are hydrolysed and removed, leaving a lignin with a higher phenolic unit content on a mass basis.

The formaldehyde will further react efficiently, thus leaving a final resin formulation having a low content of unreacted formaldehyde, which thereby is suitable for any type of applications, also those where there are regulatory restrictions for formaldehyde emissions.

The obtained resin formulation will have a controlled viscosity, achieved without the use of separate added viscosity-reducing solvents, such as methanol, which preferably are avoided in industrial processes. Thus, the number of reagents and solvents added to the mixture in the resin preparation is minimised, as well as the number of reagents and solvents that require separation from the mixture after completion of the reactions. Instead, phenol can be used to dissolve the lignin, the phenol being a component of the final resin and thus always added to the reaction mixture in at least one step of the resin preparation process.

Particularly, the acidic solution enables a better controllability of the viscosity of the final lignin-phenol-formaldehyde mixture, as well as of the final resin product. Using the preferred conditions, such as temperature and pressure, in the steps of the method, can further emphasise these advantages.

Because the viscosity can be controlled, it also becomes possible to introduce higher amounts of lignin into the final resin formulation without causing lowered reactivity or lowered resin performance. Also, an increased dry-matter content can be achieved for the final resin formulation.

These advantages are emphasised particularly in applications where low viscosity is a requirement, such as in impregnation paper.

### BRIEF DESCRIPTION OF THE DRAWING

FIG. 1 illustrates the process configuration in accordance with at least some embodiments of the present invention.

### EMBODIMENTS OF THE INVENTION

The present invention relates to a method for manufacturing a lignin-phenol-formaldehyde resin, comprising
dissolution of a lignin material in a first fraction of phenol at a pH of 0.5-3.9, at a raised temperature, in order to obtain a dissolved acidic lignin, this step being achieved without a potentially harmful increase in the molar mass of the lignin,
raising the pH of the obtained lignin solution to >9, and dosing a first fraction of formaldehyde to provide a lignin-phenol-formaldehyde mixture and to result in a methylolation reaction, the resulting mixture thus also called a methylolated lignin-phenol mixture,
forming a lignin-phenol-formaldehyde condensation mixture from the methylolated lignin-phenol mixture by adjusting the pH to ≥9.5 and agitating the mixture, optionally including the sub-steps of adding a second fraction of phenol, ensuring that the pH is ≥9.5, agitating the mixture, and adding a second fraction of formaldehyde, and
crosslinking the components of the condensation mixture resulting in a lignin-phenol-formaldehyde resin
   wherein the first fraction of phenol is 25-100 w-% of the total amount of phenol used in the method, and wherein the first fraction of formaldehyde is 50-100 w-% of the total amount of formaldehyde used in the method.

The above-mentioned additions of a second fraction of phenol and a second fraction of formaldehyde are optional when the first fractions of phenol and formaldehyde include 100% of the total amounts of phenol and formaldehyde used in the method. If the first fraction of phenol includes less than 100% of the total amount of phenol, the condensation mixture is formed in a step including the addition of the second fraction of phenol. Likewise, if the first fraction of formaldehyde includes less than 100% of the total amount of formaldehyde, the condensation mixture is formed in a step including the addition of the second fraction of formaldehyde.

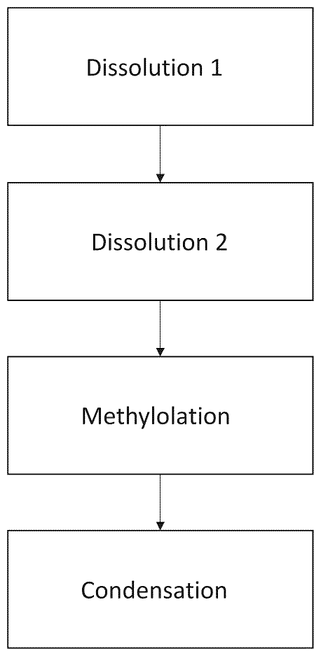

FIG. 1 shows the main stages of the above method, with Dissolution 1 being the acid dissolution mentioned above, Dissolution 2 including the raising of the pH to a level of >9, the Methylolation including the following addition of formaldehyde to the lignin-phenol solution, and the Condensation including the final steps of the above described method.

The lignin material can be selected from any lignin, such as organosolv lignin, kraft lignin, soda-pulping lignin, lignosulphonate, or enzymatic hydrolysis process lignin. Preferably, it is selected from technical softwood, hardwood or non-wood lignins obtained from lignin-containing biomass, such as wood sources and non-wood agricultural residues or perennial plants, and more preferably from organosolv-, ethanol- or kraft process lignins extracted from these lignin-containing biomasses.

In an embodiment, the lignin material is selected from hardwood lignins. In another embodiment, the lignin material is selected from organosolv lignins. The lignins of these embodiments have the most advantageous initial molecular weights, thus being particularly suitable for use in preparing resins of low molecular weight and advantageous viscosity. The lignin material is thus preferably selected from lignins having an initial molecular weight (before use in the dissolution step) of <6000 g/mol, or even <5000 g/mol, more preferably below 4500 g/mol, and most suitably below 4300 g/mol.

The sources of lignin include, for example, common softwood species such as spruce and pine, common hardwood species such as eucalyptus and birch, and common non-wood species (typically in the form of grass-type agricultural residues or perennial plants) such as bagasse, bamboo, wheat straw, rye straw, barley straw, rice straw and reed canary grass.

The phenol used in the method is typically unsubstituted phenol. Other phenolic compounds such as cresols and tannins would be suitable for use, but due to the availability of unsubstituted phenol, its use is the most convenient.

As indicated above, the first fraction of phenol is 25-100 w-% of the total amount of phenol used in the method. Preferably, the first fraction of phenol is about 50 w-% of the total amount of phenol used in the method. Similarly, the first fraction of formaldehyde is 50-100 w-% of the total amount of formaldehyde used in the method, preferably about 75 w-%.

In an embodiment of the invention, the dissolution of the lignin material using the first fraction of phenol is carried out in an aqueous solution, preferably having a water content of >30 wt-%, more preferably 40-60 w-%, thus avoiding the addition of organic solvents that would require separation from the final resin mixture. The water in the solution will prevent phenolation of the lignin during the dissolution step that might result in an unwanted increase in the viscosity of the material. Preferably a lignin content of 20-85 wt-% is used, more preferably 25-80 wt-%, or 25-60 wt-%, and most suitably 30-60 wt-%, of the combined weight of lignin and phenol in the final resin (thus describing the total amount of phenol substitution in the resin).

Typically, the dissolution is carried out at a total dry matter content of 40-60 w-%.

The pH of the reaction mixture during said phenol-based dissolution stage is typically adjusted using a phenol dose that will bring the pH of the solution to the desired level. Optionally, a small amount of additional acid can be used, preferably a mineral acid, such as sulphuric acid. However, the phenol alone usually provides sufficient acidity.

A suitable phenol dose can be, for example, one that results in a lignin-to-phenol mass ratio of >1.0, preferably 1.8-2.5, and more preferably about 2.0, at the acidic lignin dissolution stage.

The pH during the acidic dissolution is, as indicated above, 0.5-3.9, with a preferred pH range being 0.5-3.5, and a more preferred range being 2.0-3.0. When the pH has settled after phenol addition, it is typically at a level of 2.5-2.8.

A raised temperature is typically used, indicating a temperature that is above room temperature (25° C.), preferably a temperature of 50-90° C., more preferably 70-80° C. Likewise, a suitable residence time is selected to allow the reaction to be completed, such as a residence time of 30-120 min, preferably 30-60 min.

Throughout the method, when nothing else is specified, a preferred pressure is ambient pressure.

In an embodiment of the invention, the following step of the method includes raising the pH of the dissolved acidic lignin solution to >9, particularly to a pH of 9.5-10, preferably using an alkali, which can be, for example, sodium hydroxide. After the addition of the alkali, the first fraction of formaldehyde is added, preferably slowly, or over a time of 45-75 min, or about 60 min, and the temperature is preferably increased, thus facilitating the desired methylolation reaction. A suitable temperature can be a temperature of 60-75° C., preferably a temperature of about 70° C. The raised temperature is maintained under constant agitation until the reaction is completed, such as for up to 30 min, although it usually is sufficient to maintain said temperature for 10-15 min.

A condensation mixture is prepared from the methylolated lignin-phenol mixture using a method step that includes at least adjusting the pH and agitating the mixture.

In an embodiment of the invention, the condensation mixture is prepared by first adding the second fraction of phenol to the methylolated lignin-phenol mixture, while agitating and ensuring that the pH of the mixture is ≥9.5, preferably 9.5-10. Subsequently, the second fraction of formaldehyde is added, usually at a slow pace, or over a time of 45-70 min, or about 60 min, while agitating and maintaining the mixture at a temperature of, e.g., 60-75° C.

Preferably, a formaldehyde-to-phenol molar ratio of 1-2 is used for the total amount of phenol and formaldehyde used in the method, preferably 1.5-1.7, the amount of formaldehyde depending on the content of formaldehyde-reactive sites on the lignin used.

The final crosslinking step, causing the formation of the resin from this condensation mixture can be achieved by raising the temperature of the reaction mixture, preferably to a temperature of 75-95° C., more preferably 85-95° C., and maintaining the raised temperature for 15-35 min, preferably for 20-30 min.

In an example embodiment, the resin is prepared using an organosolv lignin from wheat straw. In a first step, lignin, water and phenol (in a fraction of 50% of the total phenol content in the resulting resin) are combined. With no pH adjustment, the pH settles at about 2.5. This dissolution mixture is then mixed at 70° C. for about 1 h. In the following stage, alkali is added to adjust the pH to 10, and the resulting alkali mixture is again mixed at 70° C. for about 1 h. In the following methylolation stage, formaldehyde is added (50% of the total formaldehyde content in the final resin) during a period of about 1 h at a temperature of 70° C. The mixture is then allowed to cool, and the mixing is continued for a further 10 min. The final condensation stage consists of the following successive steps: 1) addition of the rest of the phenol, 2) pH adjustment to 9.5-10, 3) addition of the rest of the formaldehyde over a period of about 1 h at 70° C., 4) increasing the temperature to 90° C. and maintaining that temperature for about 1 h, and 5) allowing the resulting product to cool to room temperature.

Using the steps of the herein described method for manufacturing lignin-phenol-formaldehyde resins, particularly using the acidic dissolution of lignin and the described order of steps enables a high efficiency for the formaldehyde reaction and viscosity control of the condensation mixture, or of the resin, typically of both.

Thus, the present invention also relates to a lignin-phenol-formaldehyde resin manufactured using the herein described method. Such a resin will typically have a viscosity of <550 cP, when measured at 20° C., preferably <350 cP, and most suitably <200 cP.

It is to be understood that the embodiments of the invention disclosed are not limited to the particular structures, process steps, or materials disclosed herein, but are extended to equivalents thereof as would be recognised by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In this description, numerous specific details are provided to provide a thorough understanding of embodiments of the invention. One skilled in the relevant art will recognise, however, that the invention can be practiced without one or more of the specific details.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The following non-limiting examples are intended merely to illustrate the advantages obtained with the embodiments of the present invention.

### EXAMPLES

### Example 1—Preparing the Resins of the Invention

Lignin-phenol-formaldehyde resins (LPF resins) were prepared using organosolv lignin from wheat straw according to four different recipes (LPF 1-LPF 4), with LPF 1 and LPF 2 being prepared in accordance with the invention, with the first step of the preparation being a dissolution in acidic conditions, and LPF 3 and LPF 4 being reference resins prepared by carrying out Dissolution 1 in alkaline conditions.

LPF 1 differs from LPF 2 particularly in the used pH level for the acidic dissolution, LPF 1 being prepared with an addition of mineral acid, thus providing an even lower pH following Dissolution 1 than the mere addition of phenol of LPF 2. LPF 3 differs from LPF 4 particularly in that LPF 4 has been prepared without phenol addition in the dissolution stages. The main steps of the recipes are shown in FIG. 1, and the further details are shown in Table 1.

TABLE 1
Preparation of resins LPF 1 and LPF 2 according to the invention, as well as reference resins LPF 3 and LPF 4

| LPF 1 | LPF 2 | LPF 3 | LPF 4 |
|---|---|---|---|
| Stage 1 (Dissolution 1): | Stage 1 (Dissolution 1): | Stage 1 (Dissolution 1): | Stage 1 (Dissolution 1): |
| Lignin, water and phenol | Lignin, water and phenol | Lignin, water and phenol | Lignin and water are |
| (50% of total in the resin) | (50% of total in the resin) | (50% of total in the resin) | combined |
| are combined | are combined | are combined | pH adjusted to 10 using |
| pH adjusted to 0.7 using | No pH adjustment (settles | pH adjusted to 10 using | sodium hydroxide |
| mineral acid | at ca. 2.5) | sodium hydroxide | Mixing at 70° C. for 1 h |
| Mixing at 70° C. for 1 h | Mixing at 70° C. for 1 h | Mixing at 70° C. for 1 h | |
| Stage 2 (Dissolution 2): | Stage 2 (Dissolution 2): | Stage 2 (Dissolution 2): | Stage 2 (Dissolution 2): |
| Alkali added to adjust | Alkali added to adjust | Alkali added to adjust | Mixing at 70° C. for 1 h |
| pH to 10 | pH to 10 | pH to 10 | at pH 10 |
| Mixing at 70° C. for 1 h | Mixing at 70° C. for 1 h | Mixing at 70° C. for 1 h | |
| Stage 3 (Methylolation): | Stage 3 (Methylolation): | Stage 3 (Methylolation): | Stage 3 (Methylolation): |
| Formaldehyde added (50% of | Formaldehyde added (50% of | Formaldehyde added (50% of | Formaldehyde added, 100% of |
| total for phenol, 100% of | total for phenol, 100% of | total for phenol, 100% of | total for lignin) over 1 h |
| total for lignin) over 1 h | total for lignin) over 1 h | total for lignin) over 1 h | at 70° C. |
| at 70° C. | at 70° C. | at 70° C. | Mixing continued for 10 min |
| Mixing continued for 10 min | Mixing continued for 10 min | Mixing continued for 10 min | |
| Stage 4 (Condensation): | Stage 4 (Condensation): | Stage 4 (Condensation): | Stage 4 (Condensation): |
| Rest of phenol added, pH | Rest of phenol added, pH | Rest of phenol added, pH | 100% of phenol added, pH |
| adjusted to 9.5-10 | adjusted to 9.5-10 | adjusted to 9.5-10 | adjusted to 9.5-10 |
| Rest of formaldehyde added | Rest of formaldehyde added | Rest of formaldehyde added | 100% of formaldehyde added |
| over 1 h at 70° C. | over 1 h at 70° C. | over 1 h at 70° C. | for phenol over 1 h at 70° C. |
| Temperature increased to | Temperature increased to | Temperature increased to | Temperature increased to |
| 90° C. and maintained for 1 h | 90° C. and maintained for 1 h | 90° C. and maintained for 1 h | 90° C. and maintained for 1 h |
| Cooling to room temperature | Cooling to room temperature | Cooling to room temperature | Cooling to room temperature |

### Example 2—Evaluation of Molecular Weight and Viscosity of Reaction Mixtures and Resins

The dissolved mixtures obtained after Stage 2 of the above Table 1 and the finished resins obtained after Stage 4 were further analysed. Particularly, the molecular weights of the dissolved mixtures and the resin viscosities were determined. The results are shown in Table 2 below.

TABLE 2
Effect of dissolution conditions on molecular weight
of dissolved lignin and LPF resin viscosity

| | Solvent in | Solvent in | Viscosity, | M_{w}, |
|---|---|---|---|---|
| | Stage 1 | Stage 2 | cPⁱ | g/molⁱⁱ |
| Lignin before | — | | — | 3660 |
| dissolution | | | | |
| LPF resin 1 | Phenol at pH 0.7 | Alkali at pH 10 | 138 | 3108 |
| LPF resin 2 | Phenol at pH 2.5 | Alkali at pH 10 | 131 | 4637 |
| LPF resin 3 | Phenol at pH 10 | Alkali at pH 10 | 301 | 5160 |
| LPF resin 4 | Alkali at pH 10 | Alkali at pH 10 | 851 | 8182 |

ⁱViscosity after Stage 4;
ⁱⁱLignin molar mass after Stage 2

As the results indicate, both the pH level of Dissolution 1 and the presence of phenol in the same Dissolution 1 affect both the molecular weight of the lignin after the dissolutions and the viscosity of the final resin.

As stated above, we hypothesise that these results would be caused by the phenol molecules, in addition to acting as a solvent, acting as a physical barrier between the lignin molecules that could otherwise condense into higher molecular weight lignin structures of reduced reactivity toward formaldehyde and giving higher resin viscosities.

Further, the acidic conditions may result in beneficial changes to the lignin structure such as cleavage of alkyl-aryl ether linkages between lignin units that reduces molar mass and increases the content of phenolic hydroxyl groups, thereby increasing lignin reactivity toward formaldehyde.

### Example 3—Evaluation of Molecular Weight and Viscosity of Reaction Mixtures and Resins Prepared from Various Raw Materials

Lignin-phenol-formaldehyde resins (LPF resins) were prepared using lignin raw materials according to the LPF2 recipe described in Table 1 of Example 1, the Stage 1 (S1) pH being between 2.5-3.7 for all lignins.

The molecular weights were determined both for the starting lignin and for the Stage 4 product. Similarly, the viscosities were determined for the Stage 4 (S4) products. The results are shown in Table 3 below.

TABLE 3
Molecular weight of lignin and LPF resins, and resin viscosity

| | | | Condensation | | |
|---|---|---|---|---|---|
| | Starting lignin | | product (S4) | | Viscosity, |
| Lignin type | Mw | Mn | Mw | Mn | cP (S4) |
| Wheat straw organosolv | 3824 | 926 | 4120 | 297 | 131 |
| Birch organosolv | 4161 | 744 | 5360 | 353 | 538 |
| Bamboo organosolv | 2927 | 809 | 4670 | 370 | 332 |
| Hardwood kraft | 2050 | 1170 | 1899 | 322 | 42 |
| Softwood kraft | 5010 | 2277 | n.d. | | 282 |

As the results indicate, the method of the invention for manufacturing LPF resins, is highly suitable for use with various lignins, and is capable of providing low-viscosity resins, while also controlling the molecular weight of the lignin component and the condensation product.

In order to provide low viscosity lignin-phenol-formaldehyde resins, it has been found advantageous to use reagents (lignin, phenol and formaldehyde) in the method that have a low molecular weight, and that also react into condensation products that have a low molecular weight. This has been achieved using the reactions conditions of the LPF2 recipe described above.

Using the mentioned reagents and the reaction conditions of the present invention, further tends to result in an LPF resin containing phenolic components of which 10-25% by mass are composed of phenol (MW 94 Da) and low-MW methylolation and condensation products of phenol and formaldehyde (MW<400 Da).

These said low-Mw methylolation and condensation products are composed typically of one or more of the following: 2-hydroxymethylphenol, 4-hydroxymethylphenol; 2,4,6-tris(Hydroxymethyl)phenol; 2,6-bis(Hydroxymethyl)phenol; 2,4-bis(Hydroxymethyl)phenol; 4,4-bis(Hydroxyphenyl)methane; 2-(Hydroxymethyl)phenol hemiformal; 4-(Hydroxymethyl)phenol hemiformal; 3,3′-bis(Hydroxymethyl)-4,4′-bis(hydroxyphenyl)methane; 3,5-bis(Hydroxymethyl)-4,4′-bis(hydroxyphenyl)methane; 3,5′-bis(Hydroxymethyl)-2,2′-bis(hydroxyphenyl)methane; 3,5-bis(Hydroxymethyl)-2,2′-bis(hydroxyphenyl)methane; 3-Hydroxymethyl-2,2′-bis(hydroxyphenyl)methane; 3-Hydroxymethyl-4,4′-bis(hydroxyphenyl)methane; 2,6-bis(Hydroxymethyl)phenol (mono)hemiformal; 2,4-bis(Hydroxymethyl)phenol (mono)hemiformal; 2,4-bis(Hydroxymethyl)phenol (di)hemiformal; 2,4,6-tris(Hydroxymethyl)phenol (mono)hemiformal; 2,4,6-tris(Hydroxymethyl)phenol (di)hemiformal; 2,4,6-tris(Hydroxymethyl)phenol (tri)hemiformal; 3,3′,5,5′-tetrakis(Hydroxymethyl)-4,4′-bis(hydroxyphenyl)methane; 3,3′,5,5′-tetrakis(Hydroxymethyl)-2,2′-bis(hydroxyphenyl)methane; tris(Hydroxymethyl)-bis(hydroxyphenyl)methanes.

By looking at the Table 3, we can see that more than 50% of the molecules in such a resin product mixture will thus have a molecular weight of below 2500 Da.

### INDUSTRIAL APPLICABILITY

The method of the invention, for manufacturing lignin-phenol-formaldehyde resins, will provide a resin having a controlled viscosity, where a portion of the phenol has been replaced with lignin to provide a more sustainable alternative. Thus, with the method of the invention, higher amounts of lignin can be introduced into the final resin formulation, compared to resins existing on the market, without causing lowered reactivity or lowered resin performance.

In particular, the formaldehyde component of lignin-phenol-formaldehyde resins will react efficiently with the solubilized mixture, leaving no free formaldehyde in the final resin formulation. Such a resin having a low content of unreacted formaldehyde is particularly suitable for any applications for which there are regulatory restrictions for formaldehyde emissions.

Due to the achieved advantageous viscosities, the resins manufactured as described herein are particularly suitable for applications such as resin to be utilized to saturate paper for which low viscosity is required.

### CITATION LIST

US20190048192 A1
WO 2015079106 A1

1. A method for manufacturing a lignin-phenol-formaldehyde resin, comprising:
dissolving a lignin material in a first fraction of phenol at a pH of 0.5-3.9, at a raised temperature, in order to obtain a dissolved acidic lignin,
raising the pH of the obtained lignin solution to >9, and dosing a first fraction of formaldehyde to provide a lignin-formaldehyde mixture and to result in a methylolation reaction,
forming a lignin-phenol-formaldehyde condensation mixture from the methylolated lignin-phenol mixture by adjusting the pH to ≥9.5 and agitating the mixture, the step optionally including adding a second fraction of phenol, ensuring that the pH is ≥9.5, agitating, and adding a second fraction of formaldehyde, and
crosslinking the components of the condensation mixture resulting in a lignin-phenol-formaldehyde resin
wherein the first fraction of phenol is 25-100 w-% of the total amount of phenol used in the method, and wherein the first fraction of formaldehyde is 50-100 w-% of the total amount of formaldehyde used in the method.

2. The method of claim 1, wherein the lignin material is selected from technical softwood, hardwood or non-wood lignin obtained from lignin-containing biomass.

3. The method of claim 1, wherein the lignin material is dissolved in the first fraction of phenol in an aqueous solution and using a lignin content of 20-85 wt-%.

4. The method of claim 1, wherein the first fraction of phenol is about 50 w-% of the total amount of phenol used in the method.

5. The method of claim 1, wherein the first fraction of formaldehyde is about 75 w-% of the total amount of formaldehyde used in the method.

6. The method of claim 1, wherein the lignin material is dissolved in a phenol dose that will bring the pH of the solution to the desired level with a lignin-to-phenol mass ratio of >1.5.

7. The method of claim 1, wherein the step of dissolving the lignin material in phenol is carried out at a pH of 2-3.

8. The method of claim 1, wherein the step of dissolving the lignin material in phenol is carried out at a temperature of 50-90° C. using a residence time of 30-120 min.

9. The method of claim 1, wherein the pH of the solution of dissolved acidic lignin is raised using sodium hydroxide to a pH of 9.5-10.

10. The method of claim 1, wherein the step of reacting the alkali lignin solution with a first fraction of formaldehyde is carried out by adding the formaldehyde to the solution having a pH of >9, and subsequently increasing the temperature to a temperature of 60-75° C.

11. The method of claim 1, wherein a formaldehyde-to-phenol molar ratio of 1-2 is used for the total amount of phenol and formaldehyde used in the method.

12. The method of claim 1, wherein the condensation mixture is obtained by first adding the second fraction of phenol to the lignin-formaldehyde mixture, ensuring that the pH of the mixture is ≥9.5, and then adding the second fraction of formaldehyde, while maintaining a temperature of the mixture at 60-75° C.

13. The method of claim 1, wherein the crosslinking is achieved by increasing the temperature of the reaction mixture to a temperature of 75-95° C., and maintaining the increased temperature for 15-35 min.

14. A lignin-phenol-formaldehyde resin manufactured using the method of claim 1.

15. The resin of claim 14, wherein the resin has a viscosity of <550 cP, when measured at 20° C.

16. A method for manufacturing a lignin-phenol-formaldehyde resin, comprising:
dissolving a lignin material in a first fraction of phenol at a pH of 0.5-3.9 to obtain a lignin solution having dissolved lignin;
raising the pH of the obtained lignin solution to >9, and dosing a first fraction of formaldehyde to form a methylolated lignin-phenol mixture;
forming a lignin-phenol-formaldehyde condensation mixture from the methylolated lignin-phenol mixture by adjusting the pH to ≥9.5, the step of forming a lignin-phenol-formaldehyde condensation mixture comprising adding a second fraction of phenol, maintaining the pH ≥9.5, and adding a second fraction of formaldehyde, and
crosslinking the components of the lignin-phenol-formaldehyde condensation mixture to provide a lignin-phenol-formaldehyde resin,
wherein the first fraction of phenol is 25-100 w-% of the total amount of phenol used in the method, and wherein the first fraction of formaldehyde is 50-100 w-% of the total amount of formaldehyde used in the method.
